(19) United States
(12) Patent Application Publication
(10) Pub. No.: US 2026/0062906 A1
(43) Pub. Date: Mar. 5, 2026

(54) Flush Valve Assembly

(71) Applicant: AS America, Inc., Piscataway, NJ (US)

(72) Inventors: Chenghao BAI, Tenafly, NJ (US); Walter PITSCH, Washington, NJ (US); Marin C. MARINOV, East Brunswick, NJ (US)

(73) Assignee: AS America, Inc., Piscataway, NJ (US)

(21) Appl. No.: 19/311,711

(22) Filed: Aug. 27, 2025

Related U.S. Application Data
(60) Provisional application No. 63/688,409, filed on Aug. 29, 2024.

(51) Int. Cl. E03D 1/34; E03D 3/06; E03D 5/10

(52) U.S. Cl. CPC E03D 1/34; E03D 3/06; E03D 5/105

(57) ABSTRACT

A flush valve assembly comprising a housing; a flush valve apparatus positioned at a housing interior; and a pressure sensor positioned at the housing interior, wherein the pressure sensor is configured to sense a water pressure, and the flush valve apparatus is configured to adjust a flush water volume delivered by the flush valve apparatus during a flush cycle in response to the sensed water pressure.

### BACKGROUND

Sanitaryware fixtures often include a flushometer flush valve apparatus, rather than a water tank of most residential-type toilets. A flushometer requires a large water supply line to operate properly. A flushometer uses the water pressure from a source water supply line to provide a high-pressure flush.

Automatic flush valves may include a diaphragm or piston separating an upper chamber (or back-pressure chamber) from a lower chamber and a main water supply. When a flush valve is in a steady state between flush cycles, water pressure in an upper chamber is in equilibrium with water pressure in a lower chamber, and presses down on a diaphragm or piston in a closed position. To initiate a flush cycle in an automatic flush valve, a solenoid valve is opened, allowing water to be released from an upper chamber through the main flush valve. This results in a drop in water pressure in an upper chamber, resulting in a diaphragm or piston to lift, and creating an opening to a main water supply, allowing water from a main water supply to flow through the main valve to a sanitaryware bowl to flush the bowl. To end a flush cycle, the solenoid valve is closed, an upper chamber is refilled with water through a small hole in a diaphragm or piston, and the diaphragm or piston returns to a closed rest position, shutting off the water supply to the sanitaryware.

A solenoid open time is related to an amount of delivered flush water. A solenoid open time is fixed, and does not account for variations in source water pressure or flow rate. Accordingly, a drop in source water pressure or flow rate may result in an insufficient flush; an increase in source water pressure or flow rate may result in the use of excess flush water. Further, a high flush volume may result in some erratic behavior, including noise, vibrations, and the like.

An improved flush valve apparatus is desired in which such undesired effects are eliminated.

Also, flush valves are typically prepared from casted brass via a machining process, resulting in valves that are heavy and costly to produce. Casted brass may also be subject to degradation if exposed to grey water. Flush valves also require high precision during manufacturing to provide a required flush performance.

Also desired are flush valves that are lightweight, are more easily manufactured with high tolerance, and which will not degrade when exposed to grey water.

### SUMMARY

Accordingly, disclosed is a flush valve assembly, comprising a housing; a flush valve apparatus positioned at a housing interior; and a pressure sensor positioned at the housing interior, wherein the pressure sensor is configured to sense a water pressure, and the flush valve apparatus is configured to adjust a flush water volume delivered by the flush valve apparatus during a flush cycle in response to the sensed water pressure.

Also disclosed is a flush valve assembly, comprising an inlet configured to receive inlet source water; an outlet configured to deliver flush water to a sanitaryware fixture; a housing; and a waterway insert configured to be positioned within the housing, wherein the housing comprises an inlet opening comprising the flush valve assembly inlet, the housing comprises an outlet opening comprising the flush valve assembly outlet, the waterway insert comprises an inlet which may be configured to align with the housing inlet opening, and the waterway insert comprises a outlet which may be configured to align with the housing outlet opening.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A and FIG. 1B provide an assembled view and an exploded view of a flush valve assembly, according to some embodiments.

FIG. 1C and FIG. 1D show an assembled view and an exploded view of a flush valve apparatus, according to some embodiments.

FIG. 1E and FIG. 1F show sectional views of a flush valve apparatus, according to some embodiments.

FIG. 1G and FIG. 1H show section views of a flush valve assembly, according to some embodiments.

FIG. 2A and FIG. 2B show views of a flush valve apparatus, according to some embodiments.

FIG. 2C and FIG. 2D provide sectional views of a flush valve apparatus, according to some embodiments.

FIG. 3A and FIG. 3B show sectional views of a flush valve assembly, according to some embodiments.

FIG. 3C provides a see-through view of a flush valve assembly, according to an embodiment.

FIG. 4A and FIG. 4B show section views of a flush valve assembly, according to some embodiments.

### DETAILED DESCRIPTION

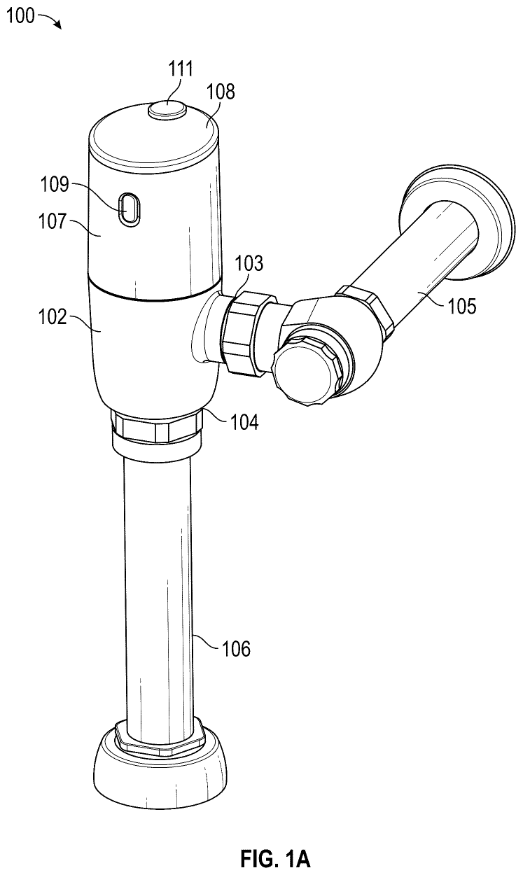

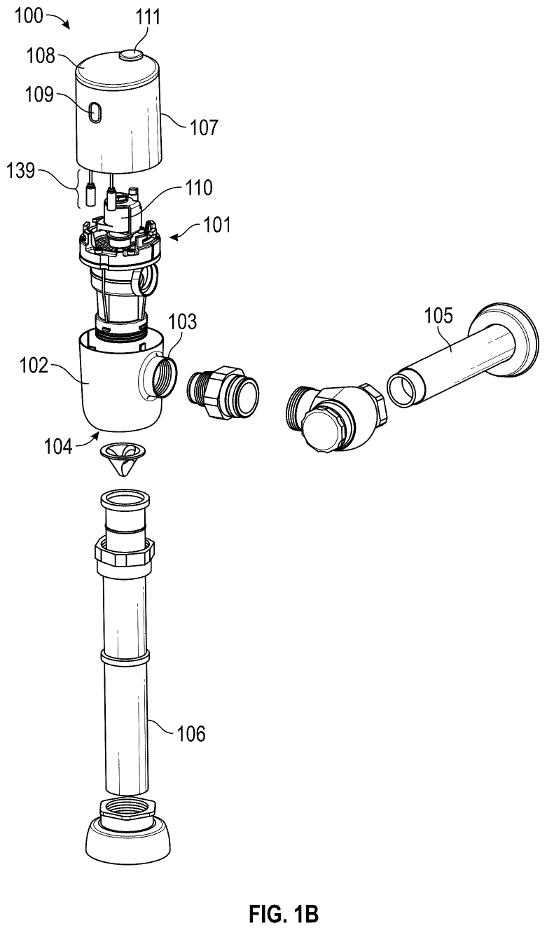

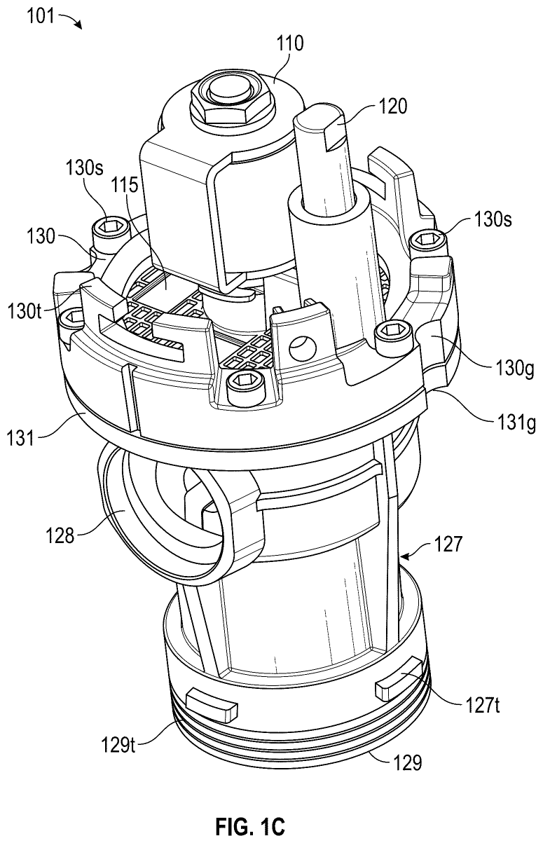

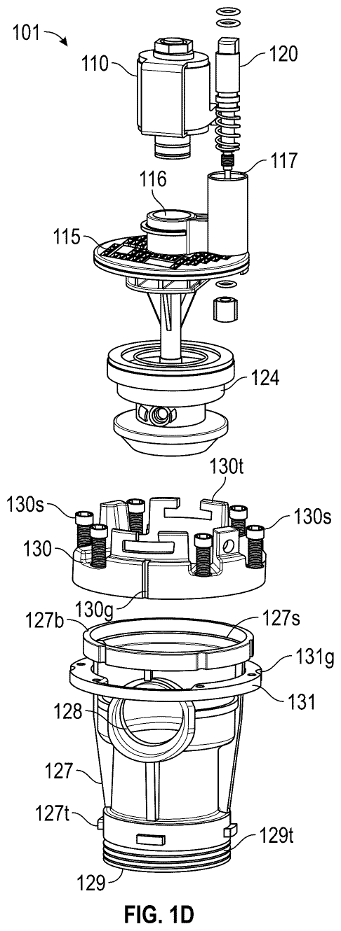

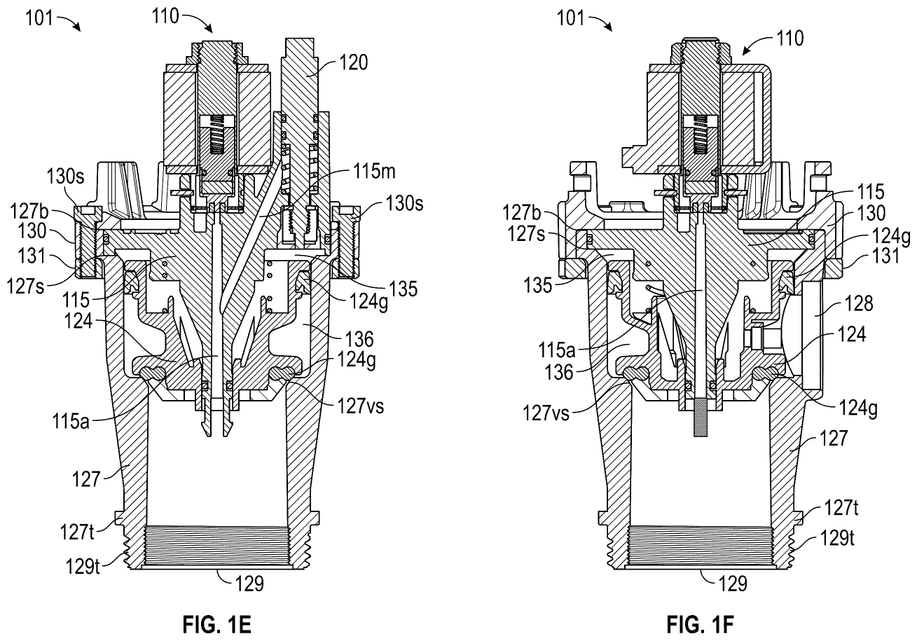

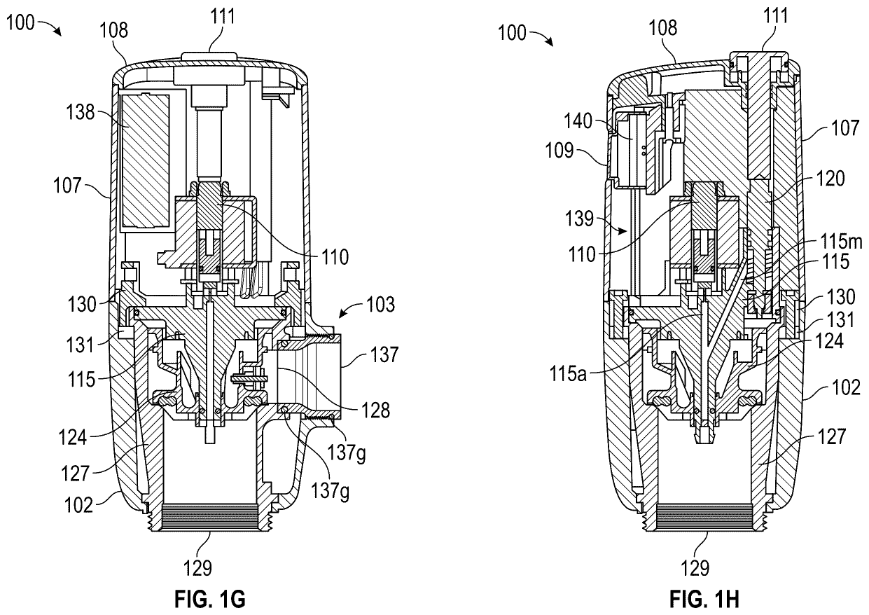

FIG. 1A shows an assembled view flush valve assembly 100, and FIG. 1B shows an exploded view, according to some embodiments. Flush valve assembly 100 may be referred to as a multi-mode apparatus, that is, it comprises an automatic flush mode and a manual flush mode. An automatic flush mode may utilize a sensor and a power source to initiate a flush. A manual flush mode may utilize a flush button not connected to a power source. Flush valve assembly 100 includes flush valve apparatus 101 positioned in lower housing 102, flush valve inlet 103 and flush valve outlet 104. Source water inlet pipe 105 is fluidly connected to flush valve assembly inlet 103 and flush water outlet pipe 106 is fluidly coupled to flush valve assembly outlet 104. Source water inlet pipe 105 is configured to be fluidly coupled to a building's plumbing system to provide water to a toilet or urinal. Flush water outlet pipe 106 is configured to be fluidly coupled to a toilet or urinal to provide flush water. Flush valve assembly 100 comprises upper housing 107 coupled to lower housing 102.

Cover 108 is positioned on a top of upper housing 107. Flush valve apparatus 100 may include a power source, for instance a battery, positioned in upper housing 107 (battery not shown). A power source is configured to be in electrical communication with a controller associated with sensor 109 and solenoid valve 110 with wires 139. Sensor 109, positioned in upper housing 107, may be configured to detect motion, presence of an object, absence of an object, sound, temperature changes, light, electromagnetic fields, alterations in reflected energy, or combinations thereof. Sensor 109 may be an active infrared (IR) presence sensor, a capacitive detection sensor, an optical detection sensor, a thermal detection sensor, or a combination thereof. In some embodiments, sensor 109 may include a microphone to enable voice activation. Any of such sensors may be considered to be a “presence sensor”. Sensor 109 may be positioned facing a user of a toilet or urinal for which flush valve apparatus 100 is installed. Flush button 111 protrudes from cover 108. Flush button 111 may be configured for a user to initiate a manual (mechanical) flush. In a manual or mechanical flush, button 111 may initiate a flush by actuating flush valve apparatus 101 without using an electronic actuator (e.g. a solenoid). A manual flush may be referred to as a “power-free flush”. Flush button 111 is not electrically connected with a power source or an electronic actuator.

FIG. 1C and FIG. 1D provide an assembled and an exploded view of flush valve apparatus 101, respectively, according to some embodiments. Valve apparatus 101 comprises manifold 115, having opening 116 to receive solenoid 110, and opening 117 to receive mechanical actuator 120. Mechanical actuator 120 is associated with button 111. Piston assembly 124 is configured to receive manifold 115. Piston assembly 124 and manifold 115 are positioned within waterway insert 127. Waterway insert 127 comprises a substantially cylinder-like shape. Waterway insert 127 comprises inlet 128 and outlet 129 having outer threaded surface 129t. Manifold 115 is positioned in waterway insert 127 with first annular securing part 130 and second annular securing part 131. In some embodiments, second securing part 131 comprises a metal, for instance stainless steel. First securing part 130 comprises locking tabs 130t, configured to mate with slots of an interior of upper housing 107. First securing part 130 comprises a plurality of grooves 130g, configured to align with a plurality of grooves 131g of second securing part 131. Together grooves 130g/131g are configured to mate with ribs of an interior of lower housing 102. A plurality of fastening screws 130s are configured to affix first securing part 130 to second securing part 131, and to hold manifold 115 in place in waterway insert 127. Waterway insert 127 comprises a plurality of tabs 127t configured to mate with slots at an interior of lower housing 102. Manifold 115 is configured to seat on waterway shoulder 127s. First annular securing part 130 is configured to seat on waterway top shoulder 127b.

FIG. 1E and FIG. 1F provide sectional views of flush valve apparatus 101, rotated 90 degrees, according to some embodiments. Piston assembly 124 comprises annular gaskets or O-rings 124g, and is shown in a closed position, resting on valve seat 127vs between flush cycles. Upon manipulating flush button 111 associated with manual actuator 120, water from upper chamber 135 is configured to pass through manifold water channel 115m, causing a drop in pressure in upper chamber 135, which will cause piston 124 to lift off valve seat 127vs, allowing source water to pass through waterway insert inlet 128 and outlet 129 to perform a flush. Water channel 115m is associated with manual actuator 120. Likewise, in an automatic mode, actuation of solenoid 110 will cause water in upper chamber 135 to pass through manifold water channel 115a, resulting in a flush. Walter channel 115a is associated with solenoid 110. During a flush cycle, water will pass through small hole in piston assembly 124 from lower chamber 136 to upper chamber 135. Once upper chamber 135 and lower chamber 136 reach an equilibrium pressure, piston assembly 124 will close to again be seated on valve seat 127vs to end a flush cycle. Waterway insert 127 comprises annular upper lip, or shoulder 127s, configured to receive manifold 115. Waterway insert 127 comprises annular top lip, or shoulder 127b, configured to receive first annular securing part 130.

FIG. 1G and FIG. 1H show sectional views of flush valve assembly 100, rotated 90 degrees, according to some embodiments. Inlet adapter 137 is threadingly coupled to lower housing 102, and is aligned with and coupled to waterway insert inlet 128 with gaskets or O-ring 137g. Also visible is battery power source 138, in wired electrical communication with controller 140 and solenoid 110 with wires 139. Controller 140 is associated with and in electrically coupled to sensor 109.

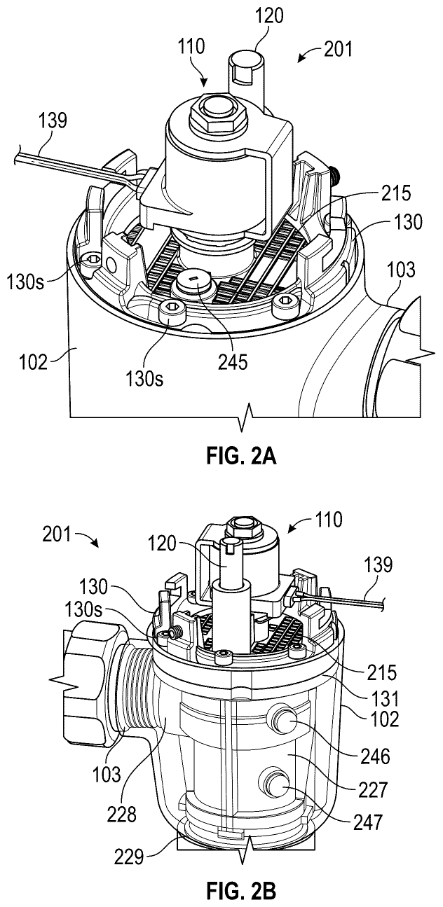

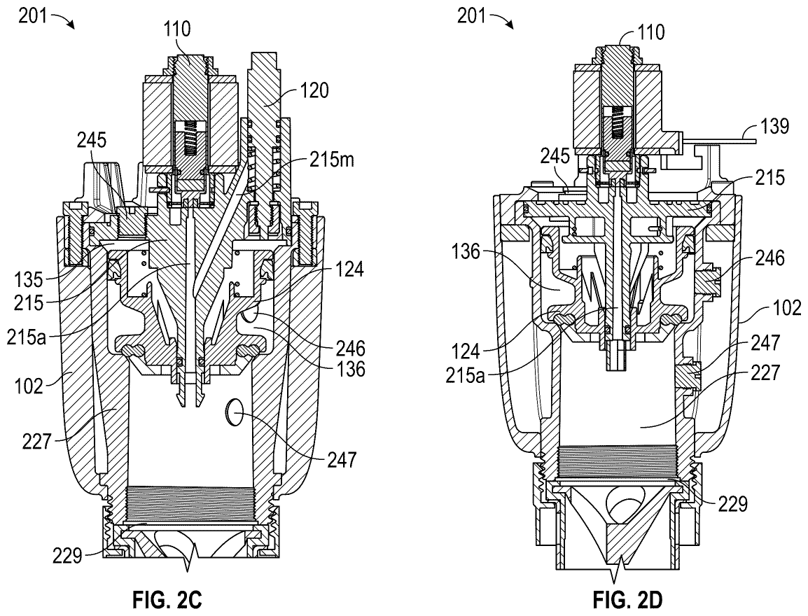

FIG. 2A shows a top view of flush valve apparatus 201, and FIG. 2B shows flush valve apparatus 201 positioned in lower housing 102 in see-through mode. Flush valve apparatus 201 comprises waterway insert 227, having manifold 215 secured thereto with first annular securing part 130, second annular securing part 131, and a plurality of screws 130s. Electric wires 139 are shown electrically coupled to solenoid 110. Manifold 215 has first pressure sensor 245 positioned in a manifold top surface, so that pressure sensor 245 is in contact with water in upper chamber 135 (not visible). Waterway insert 227 comprises second pressure sensor 246 positioned in a waterway insert side portion, such that second pressure sensor 246 is in contact with water in lower chamber 136 (not visible). Waterway insert 227 also comprises third pressure sensor 247 positioned in a waterway insert side section, such that third pressure sensor 247 is in contact with water in an outlet section below piston 124, between waterway insert 227 inlet 228 and outlet 229. First pressure sensor 245, second pressure sensor 246, and third pressure sensor 247 are in wired electrical communication with solenoid 110. First pressure sensor 245, second pressure sensor 246, and third pressure sensor 247 are configured to detect a water pressure, and flush valve apparatus 201 is configured to adjust a solenoid 110 open time in response to the sensed water pressure.

FIG. 2C and FIG. 2D provide sectional views of flush valve apparatus, 201, rotated 45 degrees, according to some embodiments. First pressure sensor 245 is positioned in manifold 215, such that first pressure sensor 245 is configured to be in contact with water in upper chamber 135. Second pressure sensor 246 is positioned in a side of waterway insert 227, and is configured to be in contact with water in lower chamber 136. Third pressure sensor 247 is positioned in a side of waterway insert 227, between waterway insert inlet 228 and outlet 229, such that it is configured to be in contact with flush water exiting waterway insert 227 during a flush cycle. Shown are manifold water channels 215a and 215m.

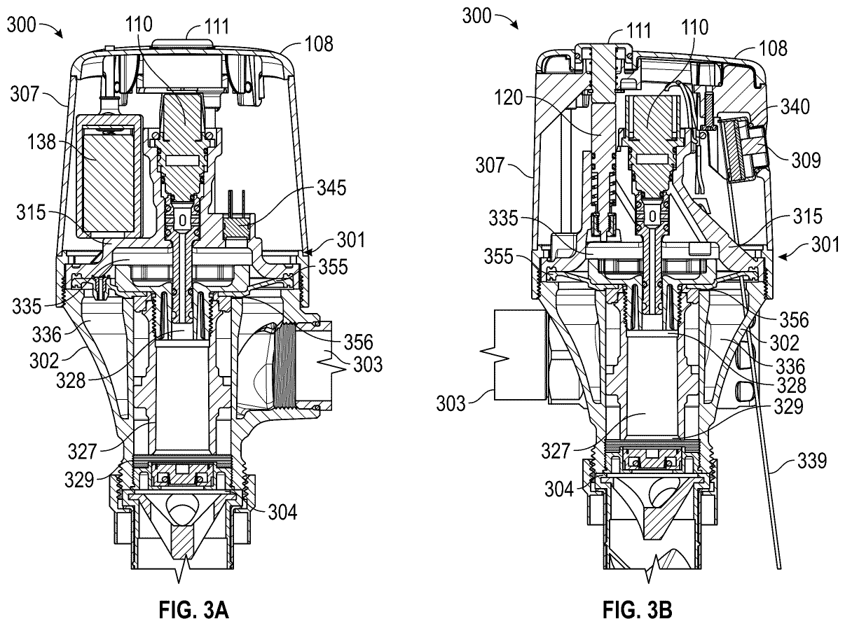

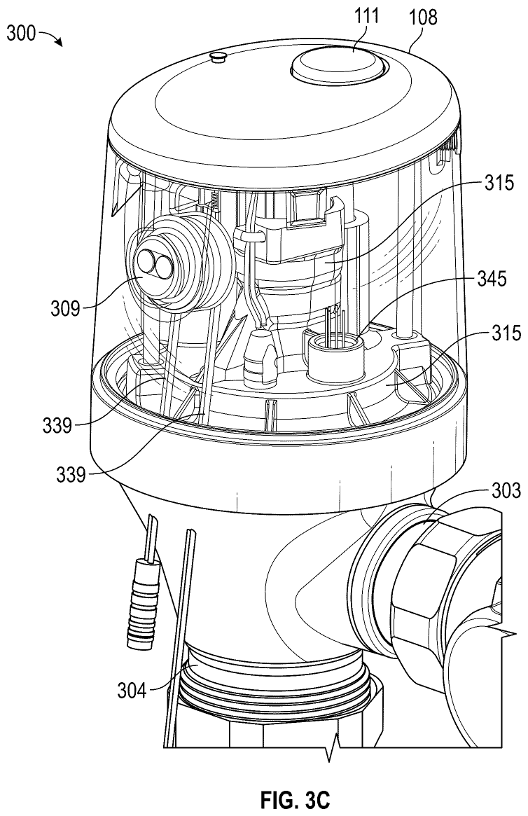

FIG. 3A and FIG. 3B show sectional views of flush valve assembly 300, rotated 90 degrees, according to some embodiments. Assembly 300 comprises flush valve inlet 303 and flush valve outlet 304, and comprises upper housing 307 and lower housing 302. Flush valve assembly 300 comprises a diaphragm flush valve apparatus 301. Shown are manual flush button 111, cover 108, and mechanical actuator 120 Flush valve apparatus 301 is positioned between upper housing 307 and lower housing 302, and comprises upper chamber 335, lower chamber 336, and diaphragm 355 positioned on valve seat 356. Flush valve apparatus 301 also comprises controller 340, presence sensor 309, battery 138, and solenoid 110. Flush valve apparatus 301 comprises pressure sensor 345 positioned in manifold 315 at upper chamber 335. Waterway insert 327 comprises inlet 328 and outlet 329. Waterway insert 327 may comprise a pressure sensor positioned at lower chamber 336 and/or between flush valve assembly inlet 328 and outlet 329. Wires 339 provide for electrical communication between power source 138, solenoid 110, controller 340, sensor 309, and pressure sensor 345.

FIG. 3C provides a see-through view of flush valve assembly 300, according to an embodiment. Visible are sensor 309, manifold 315, wires 339, assembly inlet 303, and outlet 304. Pressure sensor 345 is positioned in manifold 315.

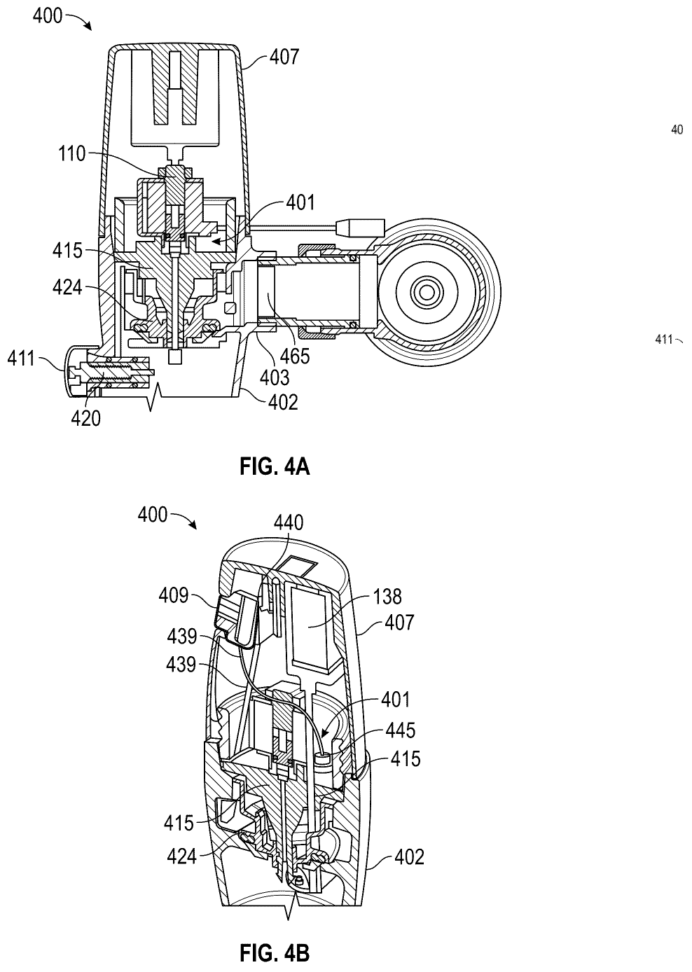

FIG. 4A and FIG. 4B show section views of flush valve assembly 400, according to some embodiments. Assembly 400 comprises upper housing 407, lower housing 402, and assembly inlet 403. Assembly 400 comprises manifold 415, piston 424, mechanical actuator 420 and button 411. Shown are wires 439 which place presence sensor 409, controller 440, battery 138, solenoid 110, and pressure sensor 445 in electrical communication. Pressure sensor 445 is positioned in a top surface of manifold 415. Assembly 400 further comprises flow regulator 465 positioned at inlet 403. Flow regulator 465 may allow for an upstream angle stop valve to be fully open, thereby allowing a plumber not to have to adjust the angle valve. Flow regulator 465 is positioned downstream of an angle stop valve (not shown) and upstream of flush valve apparatus 401.

Some embodiments of this disclosure are directed to flush valves capable of operating in different modes, including a hands-free (or automatic) mode and a mechanical (or standard or manual) mode. Multiple modes may, for example, allow a flush cycle to be initiated automatically without touching the flush valve or, alternatively, to initiate a flush by pressing a button. In some embodiments, a button for a mechanical mode is not connected to a power source for a sensor and electrical actuator (e.g. solenoid).

In some embodiments, a controller, a sensor, an electrical actuator, and a power source are in electrical communication. In some embodiments, a sensor is present on a housing of the flush valve. Electrical communication may be via a wire (e.g., electric cable) connected to the controller, sensor, the electrical actuator, and a power source. In some embodiments, a power source may be a battery, for example a rechargeable battery. In some embodiments, electrical communication may be wireless. Examples of suitable wireless communication include, but are not limited to, Wi-Fi, near field communication, Bluetooth®, ZigBee, any combination thereof, or the like.

In some embodiments, a flush valve assembly housing may comprise a metal, for example die-cast zinc, brass, or stainless steel. In some embodiments, a waterway insert may comprise a thermoplastic polymer or a metal. Thermoplastics may include a polypropylene, a polyethylene, a polyester, a polyamide, a polystyrene, mixtures thereof, or copolymers thereof. Thermoplastics may include engineering thermoplastics. Engineering thermoplastics include for example polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof. Polyamides include nylon and polyphthalamide (PPA). Polyacetals include polyoxymethylene (POM). In some embodiments, a thermoplastic polymer may comprise a glass-filled thermoplastic. Parts comprising a thermoplastic may be prepared via a molding process, for example injection molding.

A manufacturing precision of injection molded thermoplastic may advantageously be improved over that of brass casting, a typical method to prepare a flush valve.

A waterway insert may comprise a unitary construct, that is, may comprise a single part. A flush valve assembly housing may comprise a unitary construct, or may comprise a sectional construct, that is, may comprise two or more parts. Unitary and sectional constructs are illustrated in the figures.

In other embodiments, a waterway insert may comprise stainless steel. A flush valve housing may comprise a same or a different material than a waterway insert. In some embodiments, features referred to in the figures, for example one or more of an inlet adapter, first annular securing part, a piston, a manifold, or a flush valve assembly cover may comprise a thermoplastic or a metal. In some embodiments, an outer overmold layer, positioned adjacent an outer surface of a housing, may comprise a same or a different material than that of the housing. For example, an outer overmold layer may comprise zinc. An “overmold” layer may refer to an outer layer molded over another surface.

In some embodiments, a waterway insert may comprise most or all functional inner features of a typical flush valve housing. For example, a waterway insert may comprise an inlet to receive source water, and an outlet to deliver flush water to a sanitaryware fixture (e.g. a toilet or a urinal). In some embodiments, a waterway insert may comprise a valve seat. A piston or diaphragm valve assembly will rest on a valve seat in a closed position, and be lifted off a valve seat in an open position. In some embodiments, a waterway insert may comprise an upper opening configured to receive a piston or a diaphragm valve assembly. In some embodiments, a waterway insert upper opening may be configured to receive a manifold. In some embodiments, one or more of a waterway insert upper opening, bottom opening, and side opening to receive inlet source water, may each be aligned with corresponding openings of a housing within which a waterway insert is positioned. In some embodiments, when openings are aligned, this may mean they share a central axis.

In some embodiments, a waterway insert may comprise a rib positioned near a source water inlet. A rib may extend in a vertical direction, perpendicular to a flow direction of inlet source water. In some embodiments, a rib may extend from an upper inlet opening downward. In some embodiments, a rib may extend about 25%, about 30%, about 35%, about 40%, about 50%, about 55%, about 60%, or more, of a diameter of an inlet opening. In some embodiments, a rib may comprise a horizontal extension. A horizontal extension may extend from the rib towards a flow direction of inlet source water. A rib or a rib having a horizontal extension may serve to protect a valve assembly from a force of flow of inlet source water during a flush cycle.

In some embodiments, a waterway insert may comprise features configured to couple to a pipe, for example an inlet or an outlet pipe. For instance, a waterway insert may comprise an outer or an inner threaded surface positioned at an inlet or outlet and configured to couple to a pipe or an adapter.

Present pressure sensors, or “strain gauges” are configured to measure water pressure at one more points in a flush valve apparatus, between flush cycles and/or during a flush cycle. Present pressure sensors are configured to relay water pressure information to a controller, and the controller is configured to control a solenoid valve “open time”. For instance, if water pressure is above normal, a controller will instruct the solenoid to close before a typical open time, so as to maintain a desired (target) flush water volume. In another example, if water pressure is detected to be below normal, a controller will instruct the solenoid to close later than a typical open time, also to maintain the target flush water volume. In this way, a desired flush is performed, without delivering too much or too little flush water during a flush cycle.

In some embodiments, a present flush valve apparatus may include only one of the three pressure sensors, may comprise two of the three pressure sensors, or may include all three pressure sensors. In some embodiments, a pressure sensor may be in direct contact with water in an upper chamber, in a lower chamber, or in an outlet pathway of a flush apparatus. In other embodiments, a pressure sensor may not be in direct contact water.

In some embodiments, pressure sensors may be threadingly coupled to a flush valve apparatus, for instance to a manifold or to a waterway insert. In other embodiments, pressure sensors may be coupled to a flush valve apparatus with a snap-fit, adhesive bonding, etc. A waterway insert may have one or two side openings configured to receive a pressure sensor. A manifold may comprise an opening to receive a pressure sensor. Pressure sensors are configured to be in electronic communication with a controller. Monitoring of water pressure by a controller may be continuous or at defined time intervals. Water pressure monitoring may be performed between flush cycles when a flush apparatus is at rest, may be performed at one or more points during a flush cycle, or both.

Pressure sensors are for instance available from Micro Sensor Co. Ltd. Suitable micro pressure sensors may include for instance model MPM283II, MPM280AU, or MPM285, which may have a diameter of from about 12 mm to about 20 mm, and a height of from about 5 mm to about 8 mm, and may comprise stainless steel. Other micro pressure sensors are commercially available.

A manifold may comprise a thermoplastic, for example an engineering thermoplastic. A manifold may be positioned in a waterway insert and coupled to an upper end of a waterway insert, for instance by a first annular securing part and a second annular securing part. A manifold may comprise a water channel configured to allow water to pass from an upper chamber upon operation of a solenoid in an automatic mode to initiate a flush cycle. A manifold may comprise a water channel configured to allow water to pass from an upper chamber upon operation of a manual actuator in a manual mode to initiate a flush cycle.

A manifold may comprise a first opening to receive a solenoid, and may comprise a second opening to receive a manual actuator. A manifold may comprise a sensor opening to receive a pressure sensor to be positioned over a flush valve assembly upper chamber. A sensor opening may be threaded in order to threadingly couple a pressure sensor to the manifold.

Following are some non-limiting embodiments of the disclosure.

In a first embodiment, disclosed is a flush valve assembly comprising a housing; a flush valve apparatus positioned at a housing interior; and a pressure sensor positioned at the housing interior, wherein the pressure sensor is configured to sense a water pressure, and the flush valve apparatus is configured to adjust a flush water volume delivered by the flush valve apparatus during a flush cycle in response to the sensed water pressure.

In a second embodiment, disclosed is a flush valve assembly according to embodiment 1, wherein the pressure sensor is coupled to the flush valve apparatus. In a third embodiment, disclosed is a flush valve assembly according to embodiments 1 or 2, wherein the flush valve apparatus comprises an inlet, an outlet, an upper chamber, and a lower chamber, and a first pressure sensor positioned at the upper chamber, and/or a second pressure sensor positioned at the lower chamber, and/or a third pressure sensor positioned between the flush valve assembly inlet and outlet.

In a fourth embodiment, disclosed is a flush valve assembly according to embodiment 3, comprising the first pressure sensor. In a fifth embodiment, disclosed is a flush valve assembly according to embodiments 3 or 4, comprising the second pressure sensor. In a sixth embodiment, disclosed is a flush valve assembly according to any of embodiments 3 to 5, comprising the third pressure sensor.

In a seventh embodiment, disclosed is a flush valve assembly according to any of the preceding embodiments, wherein the flush valve apparatus comprises a controller, a presence sensor, a pressure sensor, a power source, and a solenoid valve, the controller, the presence sensor, the pressure sensor, the power source, and the solenoid valve are in electrical communication, the controller is configured to instruct the solenoid valve to open to initiate the flush cycle upon receiving a presence sensor signal from the presence sensor, the controller is configured to instruct the solenoid valve to close to end the flush cycle, the controller is configured to receive the sensed water pressure from the pressure sensor, and the controller is configured to adjust a solenoid valve open time in response to the sensed water pressure.

In an eighth embodiment, disclosed is a flush valve assembly according to embodiment 7, comprising a manifold having a first opening configured to receive the solenoid valve, wherein a manifold lower surface is positioned over the upper chamber. In a ninth embodiment, disclosed is a flush valve assembly according to embodiment 8, wherein the first pressure sensor is positioned at a manifold upper surface. In a tenth embodiment, disclosed is a flush valve assembly according to embodiment 9, wherein the manifold comprises a sensor opening configured to receive the first pressure sensor.

In an eleventh embodiment, disclosed is a flush valve assembly according to any of the preceding embodiments, comprising a waterway insert having a waterway insert inlet and outlet. In a twelfth embodiment, disclosed is a flush valve assembly according to embodiment 11, wherein the second pressure sensor is positioned on the waterway insert adjacent to the lower chamber. In a thirteenth embodiment, disclosed is a flush valve assembly according to embodiment 12, wherein the waterway insert comprises an upper side opening configured to receive the second pressure sensor.

In a fourteenth embodiment, disclosed is a flush valve assembly according to embodiment 11, wherein the third pressure sensor is positioned on the waterway insert between the waterway insert inlet and outlet. In a fifteenth embodiment, disclosed is a flush valve assembly according to embodiment 14, wherein the waterway insert comprises a lower side opening configured to receive the third pressure sensor. In a sixteenth embodiment, disclosed is a flush valve assembly according to any of embodiments 11 to 15, wherein the manifold is positioned in an upper end of the waterway insert.

In a seventeenth embodiment, disclosed is a flush valve assembly according to any of the preceding embodiments, wherein the flush valve apparatus comprises a piston. In an eighteenth embodiment, disclosed is a valve assembly according to any of embodiments 1 to 16, wherein the flush valve apparatus comprises a diaphragm.

In a nineteenth embodiment, disclosed is a flush valve assembly according to any of embodiments 8 to 18, wherein the manifold comprises a second opening configured to receive a manual actuator. In a twentieth embodiment, disclosed is a flush valve assembly according to embodiment 19, wherein the flush valve assembly is configured to perform an automatic flush cycle when the solenoid valve is actuated, and to perform a manual flush cycle when the manual actuator is actuated.

In a twenty-first embodiment, disclosed is a flush valve assembly according to any of the preceding embodiments, comprising a flow regulator positioned upstream of the flush valve apparatus.

Another set of non-limiting embodiments of the disclosure include the following.

In a first embodiment, disclosed is a flush valve assembly comprising an inlet configured to receive inlet source water; an outlet configured to deliver flush water to a sanitaryware fixture; a housing; and a waterway insert configured to be positioned within the housing, wherein the housing comprises an inlet opening comprising the flush valve assembly inlet, the housing comprises an outlet opening comprising the flush valve assembly outlet, the waterway insert comprises an inlet which may be configured to align with the housing inlet opening, and the waterway insert comprises an outlet which may be configured to align with the housing outlet opening.

In second embodiment, disclosed is a flush valve assembly according to embodiment 1, wherein the waterway insert comprises a thermoplastic. In a third embodiment, disclosed is a flush valve assembly according to embodiments 1 or 2, wherein the waterway insert comprises a glass-filled thermoplastic or an engineering thermoplastic.

In a fourth embodiment, disclosed is a flush valve assembly according to any of the preceding embodiments, wherein the waterway insert comprises an upper top opening configured to receive a piston or a diaphragm valve apparatus. In a fifth embodiment, disclosed is a flush valve assembly according to any of the preceding embodiments, wherein the waterway insert comprises no opening configured to receive a manual flush assembly.

In a sixth embodiment, disclosed is a flush valve assembly according to any of the preceding embodiments, wherein the waterway insert comprises an upper side opening configured to receive a pressure sensor, and wherein the upper side opening is configured to be positioned adjacent a flush valve assembly lower chamber. In a seventh embodiment, disclosed is a flush valve assembly according to any of the preceding embodiments, wherein the waterway insert comprises a lower side opening configured to receive a pressure sensor, and wherein the lower side opening is configured to be positioned between the waterway insert inlet and the waterway insert outlet. In an eighth embodiment, disclosed is a flush valve assembly according to embodiment 6, wherein the upper side opening is threaded. In a ninth embodiment, disclosed is a flush valve assembly according to embodiment 7, wherein the lower side opening is threaded.

In a tenth embodiment, disclosed is a flush valve assembly according to any of the preceding embodiments, wherein the waterway insert includes a valve seat. In an eleventh embodiment, disclosed is a flush valve assembly according to any of the preceding embodiments, wherein the waterway insert comprises an upper annular shoulder configured to receive a valve manifold.

In a twelfth embodiment, disclosed is a flush valve assembly according to any of the preceding embodiments, wherein the waterway insert comprises a top annular shoulder configured to receive a first annular securing part. In a thirteenth embodiment, disclosed is a flush valve assembly according to embodiment 12, comprising a second annular securing part configured to couple to the first annular securing part and to position the waterway insert in the housing. In a fourteenth embodiment, disclosed is a flush valve assembly according to embodiment 13, wherein the first annular securing part and the second annular securing part are configured to secure the manifold in the waterway insert. In a fifteenth embodiment, disclosed is a flush valve assembly according to embodiment 13 or 14, wherein the first annular securing part comprises a thermoplastic, and the second annular securing part comprises a metal.

In a sixteenth embodiment, disclosed is a flush valve assembly according to any of the preceding embodiments, wherein the waterway insert comprises a substantially cylinder-like shape. In a seventeenth embodiment, disclosed is a flush valve assembly according to any of the preceding embodiments, comprising a manifold coupled to an upper end of the waterway insert. In an eighteenth embodiment, disclosed is a flush valve assembly according to embodiment 17, wherein the manifold comprises a thermoplastic.

In a nineteenth embodiment, disclosed is a flush valve assembly according to any of embodiments 11 to 18, wherein the manifold comprises a first opening configured to receive a solenoid, wherein a manifold lower surface is positioned over a flush valve assembly upper chamber. In a twentieth embodiment, disclosed is a flush valve assembly according to any of embodiments 11 to 19, wherein the manifold comprises a second opening configured to receive a manual actuator. In a twenty-first embodiment, disclosed is a flush valve assembly according to any of embodiments 11 to 20, wherein the manifold comprises a sensor opening configured to receive a pressure sensor. In a twenty-second embodiment, disclosed is a flush valve assembly according to embodiment 21, wherein the sensor opening is threaded.

The term “flow communication” or “fluid communication” means for example configured for liquid or gas flow there through and may be synonymous with “fluidly coupled”. The terms “upstream” and “downstream” indicate a direction of gas or fluid flow, that is, gas or fluid will flow from upstream to downstream.

Likewise, “electrical communication” may mean “electrically coupled”. Electrical communication may be via wired connection or may be wireless.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together”in that one may function together with the other.

The term “towards” in reference to a of point of attachment, may mean at exactly that location or point or, alternatively, may mean closer to that point than to another distinct point, for example “towards a center”means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10% of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A flush valve assembly, comprising
a housing;
a flush valve apparatus positioned at a housing interior; and
a pressure sensor positioned at the housing interior,
wherein
the pressure sensor is configured to sense a water pressure, and
the flush valve apparatus is configured to adjust a flush water volume delivered
by the flush valve apparatus during a flush cycle in response to the sensed water pressure.

2. The flush valve assembly according to claim 1, wherein the pressure sensor is coupled to the flush valve apparatus.

3. The flush valve assembly according to claim 2, wherein the flush valve apparatus comprises
an inlet, an outlet, an upper chamber, and a lower chamber, and
a first pressure sensor positioned at the upper chamber, and/or
a second pressure sensor positioned at the lower chamber, and/or
a third pressure sensor positioned between the flush valve assembly inlet and outlet.

4. The flush valve assembly according to claim 3, comprising the first pressure sensor.

5. The flush valve assembly according to claim 3, comprising the second pressure sensor.

6. The flush valve assembly according to claim 3, comprising the third pressure sensor.

7. The flush valve assembly according to claim 1, wherein
the flush valve apparatus comprises a controller, a presence sensor, a power source, and a solenoid valve,
the controller, the presence sensor, the pressure sensor, the power source, and the solenoid valve are in electrical communication,
the controller is configured to instruct the solenoid valve to open to initiate the flush cycle upon receiving a presence sensor signal from the presence sensor,
the controller is configured to instruct the solenoid valve to close to end the flush cycle,
the controller is configured to receive the sensed water pressure from the pressure sensor, and
the controller is configured to adjust the solenoid valve open time in response to the sensed water pressure.

8. The flush valve assembly according to claim 3, comprising a manifold having a first opening configured to receive the solenoid valve, wherein a manifold lower surface is positioned over the upper chamber.

9. The flush valve assembly according to claim 8, comprising the first pressure sensor positioned at a manifold upper surface.

10. The flush valve assembly according to claim 9, wherein the manifold comprises a sensor opening configured to receive the first pressure sensor.

11. The flush valve assembly according to claim 8, comprising a waterway insert having a waterway insert inlet and outlet.

12. The flush valve assembly according to claim 11, comprising the second pressure sensor positioned on the waterway insert adjacent to the lower chamber.

13. The flush valve assembly according to claim 12, wherein the waterway insert comprises an upper side opening configured to receive the second pressure sensor.

14. The flush valve assembly according to claim 11, comprising the third pressure sensor positioned on the waterway insert between the waterway insert inlet and outlet.

15. The flush valve assembly according to claim 14, wherein the waterway insert comprises a lower side opening configured to receive the third pressure sensor.

16. The flush valve assembly according to claim 11, wherein the manifold is positioned in an upper end of the waterway insert.

17. The flush valve assembly according to claim 1, wherein the flush valve apparatus comprises a piston.

18. The flush valve assembly according to claim 1, wherein the flush valve apparatus comprises a diaphragm.

19. The flush valve assembly according to claim 1, comprising a flow regulator positioned upstream of the flush valve apparatus.

20. The flush valve assembly according to claim 19, wherein the flush valve assembly is configured to perform an automatic flush cycle when the solenoid valve is actuated, and to perform a manual flush cycle when a manual actuator is actuated.
